(19) United States
(12) Patent Application Publication
(10) Pub. No.: US 2014/0168856 A1
(43) Pub. Date: Jun. 19, 2014

(54) ASYMMETRIC ELECTROCHEMICAL CAPACITOR POSITIVE ELECTRODE COMPOSITION AND ASYMMETRIC ELECTROCHEMICAL CAPACITOR CELLS AND DEVICES COMPRISING SAME

(71) Applicant: GENERAL ELECTRIC COMPANY, Schenectdy, NY (US)

(72) Inventors: Michael Alan VALLANCE, Niskayuna, NY (US); David Charles BOGDAN, JR., Niskayuna, NY (US); Brandon Alan BARTLING, Niskayuna, NY (US)

(73) Assignee: GENERAL ELECTRIC COMPANY, Schenectady, NY (US)

(21) Appl. No.: 13/718,317

(22) Filed: Dec. 18, 2012

(51) Int. Cl. H01G 9/045; H01G 9/032

(52) U.S. Cl. CPC H01G 9/045; H01G 9/032
USPC 361/525; 361/529

(57) ABSTRACT

An asymmetric electrochemical capacitor positive electrode composition including activated carbon and an electrolyte salt which is a reaction product of an alkali metal halide and an aluminum halide is provided. Asymmetric electrochemical capacitor cells and energy storage devices comprising the asymmetric electrochemical capacitor positive electrode composition are also provided.

### BACKGROUND

The invention includes embodiments that relate to an asymmetric electrochemical capacitor positive electrode composition, and to asymmetric electrochemical capacitor cells and devices comprising the asymmetric electrochemical capacitor positive electrode composition.

High temperature batteries, including sodium batteries such as sodium metal halide batteries, may exhibit poor charge acceptance and charge acceptance degradation.

Thus, a need exists for electrochemical cells and storage devices having improved properties, such as, for example, improved charge acceptance and charge acceptance degradation.

### SUMMARY

Briefly, the present invention satisfies the need for improved electrochemical cells and devices. The present invention may address one or more of the problems and deficiencies of the art discussed above. However, it is contemplated that the invention may prove useful in addressing other problems and deficiencies in a number of technical areas. Therefore, the claimed invention should not necessarily be construed as limited to addressing any of the particular problems or deficiencies discussed herein.

In one aspect, the invention relates to an asymmetric electrochemical capacitor positive electrode composition. The asymmetric electrochemical capacitor positive electrode composition includes activated carbon and an electrolyte salt. The electrolyte salt includes a reaction product of an alkali metal halide and an aluminum halide.

In another aspect, the invention relates to an asymmetric electrochemical capacitor cell. The cell comprises an outer housing and a separator, which is disposed in the outer housing, and which defines a positive electrode compartment and a negative electrode compartment in the cell. The positive electrode compartment includes an asymmetric electrochemical capacitor positive electrode composition, which includes activated carbon and an electrolyte salt that includes a reaction product of an alkali metal halide and an aluminum halide.

In another aspect, the invention relates to an energy storage device. The device includes a plurality of electrochemical cells housed in a case. At least one of the plurality of electrochemical cells is a cell that includes an asymmetric electrochemical capacitor positive electrode composition, which includes activated carbon and an electrolyte salt that includes a reaction product of an alkali metal halide and an aluminum halide.

Certain embodiments of the presently-disclosed asymmetric electrochemical capacitor positive electrode composition, and asymmetric electrochemical capacitor cells and devices comprising the asymmetric electrochemical capacitor positive electrode composition have several features, no single one of which is solely responsible for their desirable attributes. Without limiting the scope of the asymmetric electrochemical capacitor positive electrode composition, and asymmetric electrochemical capacitor cells and devices comprising the asymmetric electrochemical capacitor positive electrode composition as defined by the claims that follow, their more prominent features will now be discussed briefly. After considering this discussion, and particularly after reading the section of this specification entitled “Detailed Description”, one will understand how the features of the various embodiments disclosed herein provide a number of advantages over the current state of the art. These advantages may include, without limitation, improved charge acceptance, improved charge acceptance degradation, and/or reduced ionic resistivity.

These and other features and advantages of this invention will become apparent from the following detailed description of various aspects of the invention taken in conjunction with the appended claims and the accompanying drawings.

### BRIEF DESCRIPTION OF THE FIGURES

FIG. 1 shows a partial internal view of an embodiment of an asymmetric electrochemical capacitor cell according to the present disclosure.

FIG. 2 shows a perspective view of a battery incorporating an asymmetric electrochemical capacitor cell according to the present disclosure.

FIG. 3 shows a simple schematic representing the testing setup used to test various embodiments of the present disclosure.

FIG. 4 is a chart showing rate dependency of several embodiments of the present disclosure.

FIG. 5 is a chart showing the stability of a cell according to one embodiment of the present disclosure over 5 cycles.

FIG. 6 is a chart showing the stability of a cell according to one embodiment of the present disclosure over 6 cycles.

FIG. 7 is a chart showing that a cell according to one embodiment of the present disclosure behaves consistently at both a high state of charge and a low state of charge.

FIG. 8 is a chart showing capacity of a cell according to an embodiment of the present disclosure as a function of rate.

FIG. 9 is a chart showing capacity of a cell according to another embodiment of the present disclosure as a function of rate.

FIG. 10 is a chart showing that a cell according to one embodiment of the present disclosure stably holds its open circuit voltage (OCV) at top of charge and bottom of charge.

### DETAILED DESCRIPTION

The invention is generally directed to an asymmetric electrochemical capacitor positive electrode composition, and to asymmetric electrochemical capacitor cells and devices comprising the asymmetric electrochemical capacitor positive electrode composition.

Although this invention is susceptible to embodiment in many different forms, certain embodiments of the invention are described. It should be understood, however, that the present disclosure is to be considered as an exemplification of the principles of this invention and is not intended to limit the invention to the embodiments illustrated.

High temperature cells and storage devices such as batteries (e.g. sodium batteries, such as sodium metal halide batteries) often exhibit poor charge acceptance and charge acceptance degradation, which may be due to low chloride activity in acidified molten-salt electrolyte in the cathode. Further, repeated oxidation of the metal in the positive electrode (cathode) (e.g. oxidation of the nickel current collection grid of the positive electrode) can result in degraded performance. The instant invention replaces the traditional cathode material with an asymmetric electrochemical capacitor positive electrode composition (referred to throughout the disclosure interchangeably as the “positive electrode composition”) that overcomes disadvantages of the prior art. Further, the asymmetric electrochemical capacitor positive electrode composition, asymmetric electrochemical capacitor cells, and devices incorporating the same of the present disclosure are expected to provide a more open structure, thereby reducing ionic resistivity. Further, the invention is less vulnerable to high temperature degradation, thus permitting operation at increased temperature, where ionic resistivity is reduced.

In one aspect, the invention relates to an asymmetric electrochemical capacitor positive electrode composition, which is a positive electrode composition for use in an asymmetric electrochemical capacitor cell. An asymmetric electrochemical capacitor cell uses two different energy conversion processes, proceeding on different electrodes of one cell. Energy is stored in one electrode as an electric double layer, while energy is stored in a second electrode by faradaic processes.

The asymmetric electrochemical capacitor positive electrode composition includes activated carbon and an electrolyte salt. The electrolyte salt includes a reaction product of an alkali metal halide and an aluminum halide.

In some embodiments, the alkali metal of the alkali metal halide is selected from sodium, potassium, and lithium.

The halide of the alkali halide and the halide of the aluminum halide are independently selected from fluorine, chlorine, bromine, and iodine. In some embodiments, the halide of the alkali halide and the halide of the aluminum halide are the same, while in some embodiments, they are different. In some embodiments, one or both of the halide of the alkali halide and the halide of the aluminum halide are chlorine.

In some embodiments, the electrolyte salt includes a reaction product of sodium chloride (NaCl) and aluminum chloride (AlCl₃). The preferred electrolyte salt comprises sodium tetrachloroaluminate (NaAlCl₄) and binary compositions of NaCl and AlCl₃ which are near this composition.

The activated carbon of the asymmetric electrochemical capacitor positive electrode composition is charcoal that has been heated or otherwise treated to increase its adsorptive properties (as opposed to, for example, carbon black). For example, in some embodiments, the carbon may be an acid washed steam activated carbon (e.g., Norit SX Ultra). In some embodiments, the carbon may be a high surface area activated carbon (e.g., Kuraray Chemical YP-50F or YP-80F). In some embodiments, the carbon in the positive electrode composition represents 5 to 50 weight % of the positive electrode composition, for example, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 wt % including any and all ranges and subranges therein (e.g., 5-25 wt %, 10-20 wt %, etc.).

In some embodiments, the asymmetric electrochemical capacitor positive electrode composition does not include an electroactive metal (i.e., the positive electrode composition excludes electroactive metal).

In another aspect, the invention relates to an asymmetric electrochemical capacitor cell. The cell comprises an outer housing and a separator, which is disposed in the outer housing, and which defines a positive electrode compartment and a negative electrode compartment in the cell. The positive electrode compartment includes the asymmetric electrochemical capacitor positive electrode composition described above. The separator permits for ionic communication, meaning the traversal of ions, between the positive electrode compartment and the negative electrode compartment.

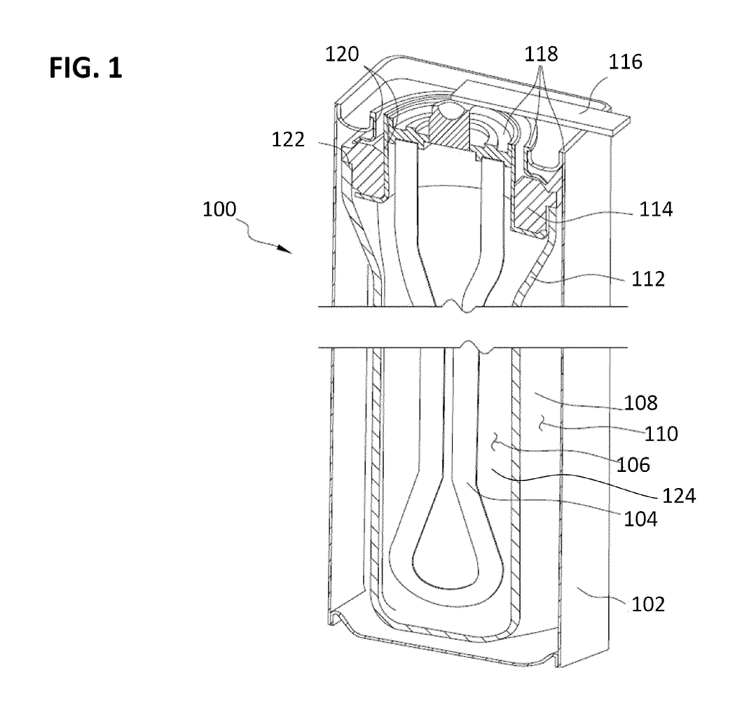

Referring to FIG. 1, an asymmetric electrochemical capacitor cell 100 according to an embodiment of the invention is provided. The asymmetric electrochemical capacitor cell 100 includes an outer housing 102, a positive electrode current collector 104, a positive electrode compartment 124, asymmetric electrochemical capacitor positive electrode composition 106, a negative electrode compartment 108, anodic material 110, a separator 112, a collar 114, an interconnect 116, two connected bridge pieces of the case 118, two ring structures 120 to connect the bridge pieces to the collar and a ceramic-ceramic seal 122. Apart from certain exceptions detailed herein, the components of the asymmetric electrochemical capacitor cell may, in general, be prepared of materials, and using techniques generally known in the art of and relating to electrochemical cells that allow the electrochemical cell to function according to the present disclosure.

According to certain embodiments, to charge asymmetric electrochemical capacitor cell 100, a positive potential is impressed on the asymmetric electrochemical capacitor positive electrode composition. Negatively charged ions (e.g., chloride, fluoride, bromide, chloroaluminates, fluoroaluminates, iodoaluminates, bromoaluminates, sulfides, etc.), which are soluble in the electrolyte, electromigrate to the surface of the cathode media to form a double layer. A negative potential is impressed on the anode current collection system. Ions (e.g., sodium) from the positive electrode electrolyte electromigrate into and through the separator 112 and pool (e.g., as molten sodium), after electrochemical reduction.

During a discharge cycle of asymmetric electrochemical capacitor cell 100, ions migrate from anodic material 110 contained within negative electrode compartment 108 after electrochemical oxidation through separator 112 to asymmetric electrochemical capacitor positive electrode composition 106 in positive electrode compartment 124. In one embodiment, the outer housing 102 also functions as an anode current collector (i.e., a negative pole of the electrochemical cell).

In some embodiments, anodic material 110 only fills a portion of negative electrode compartment 108. The transfer of ions occurs at the contact area of anodic material 110 with separator 112. In some embodiments (not shown in FIG. 1), asymmetric electrochemical capacitor cell 100 may comprise a set of metallic foils that form a close-fitting, segmented shell around the separator, called shims. The thin annular volume between the separator and the metallic shell is filled with sodium metal covering the anode-facing surface of the separator.

The outer housing may be sized and shaped as desired and may, for example, have a cross-sectional profile that is square, polygonal, or circular. The housing can be formed from a material that is a metal, ceramic, or a composite; or some combination thereof. The metal can be selected from, inter alia, nickel or steel, as examples; and the ceramic is often a metal oxide.

The separator may be, for example, an alkali metal ion conductor solid electrolyte that conducts alkali metal ions during use between the positive electrode compartment and the negative electrode compartment. Certain acceptable separator materials are discussed in J. W. Fergus, “Ion transport in sodium ion conducting solid electrolytes”, Solid State Ionics 227 (2012) 102-112, which is incorporated herein in its entirety. Suitable materials for the separator may include an alkali-metal-beta′-alumina, alkali-metal-beta″-alumina, alkali-metal-beta′-gallate, or alkali-metal-beta″-gallate. In various embodiments, the separator may include a beta-alumina, a beta″-alumina, a gamma alumina, or a micromolecular sieve such as, for example, a tectosilicate, such as a felspar, or a felspethoid. Other exemplary separator materials include zeolites, for example a synthetic zeolite such as zeolite 3A, 4A, 13X, ZSM-5; rare-earth silicophosphates; silicon nitride; or a silicophosphate; a beta′-alumina; a beta″-alumina; a gamma alumina; a micromolecular sieve; or a silicophosphate (NASICON: Na₃Zr₂Si₂PO₁₂). In certain embodiments, the separator includes a beta alumina. In some embodiments, the separator may be essentially non-porous, and/or monolithic, for example a non-porous, and/or monolithic membrane. In some embodiments, the separator is beta or beta″ alumina. In some embodiments, the separator is a solid separator capable of transporting sodium cations between the positive electrode compartment and the negative electrode compartment.

The separator may be sized and shaped as desired. For example, in some embodiments, the separator may have a cross-sectional profile that is square, polygonal, circular, or clover leaf, to provide a maximum surface area for alkali metal ion transport. In some embodiments, separator 112 is formed in an irregular shape (e.g., non-symmetric). In other embodiments, separator 112 is formed as a regular (e.g., symmetric) shape, such as a cloverleaf shape. In some instances the separator is flat, and the cell is prismatic.

In various embodiments, the separator may be stabilized by the addition of small amounts of one or more dopants. For example, when the separator is beta or beta″ alumina, the dopant may include one or more oxides selected from, e.g., lithia, magnesia, zinc oxide, and yttria. These stabilizers may be used alone or in combination with themselves, or with other materials.

Typically, negative electrode compartment 108 is empty or nearly empty in the ground state (uncharged state) of the asymmetric electrochemical capacitor cell, and is filled, at least partially, with metal from reduced metal ions that move from the positive electrode compartment to the negative electrode compartment through the separator, during operation of the cell. In some embodiments, the anodic material is an ionic material transported across the separator between the negative electrode compartment and the positive electrode compartment. Suitable ionic materials may include cationic forms of one or more of sodium, lithium and potassium. The anodic material, for example, an anodic material comprising or consisting of sodium, is molten during use. Additives suitable for use in the anodic material may include, for example, a metal oxygen scavenger. Suitable metal oxygen scavengers may include, e.g., one or more of manganese, vanadium, zirconium, aluminum, or titanium. Other useful additives may include materials that increase wetting of the separator surface defining the negative electrode compartment, by the molten anodic material. Additionally, some adherent foils or coatings may enhance the contact or wetting between the separator and the current collector, to ensure substantially uniform current flow throughout the separator.

In some embodiments, an anode contact layer (not shown) of conductive porous particles or material applied as a thin layer, e.g., less than 0.5 mm thick, is applied between the separator 112 and other layers of the asymmetric electrochemical capacitor cell 100. The anode contact layer may be any material that allows the asymmetric electrochemical capacitor cell to operate as desired. In some embodiments, the anode contact layer is a carbon layer, which may be applied as an aqueous paint/slurry bonded to the separator 112 using, e.g., sodium phosphate glass binder.

In some embodiments, asymmetric electrochemical capacitor cell 100 includes case 102 of any shape that allows electrochemical cell 100 to function in accordance with the present disclosure, for example a polygonal shape, a cylindrical shape and the like. In one embodiment, case 102 has dimensions of approximately 36 mm×36 mm×230 mm. In another embodiment, separator 112 has a height of approximately 220 mm.

In some embodiments, asymmetric electrochemical capacitor cell 100 is a molten salt battery including sodium tetrachloroaluminate (NaAlCl₄) as electrolyte, which melts (i.e. becomes molten) at approximately 157° C.

According to some embodiments, the asymmetric electrochemical capacitor cell of the invention is operational in the temperature range of approximately 200° C. to 500° C., for example, 200° C., 225° C., 250° C., 275° C., 300° C., 325° C., 350° C., 375° C., 400° C., 425° C., 450° C., 475° C., or 500° C., including any and all ranges and subranges therein (e.g., 200 to 500° C., 250 to 450° C., 275 to 425° C., etc.).

According to some embodiments, the asymmetric electrochemical capacitor cell of the invention is operational over the voltage range of 1.5 to 4.5 V, for example, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, or 4.5 V, including any and all ranges and subranges therein (e.g., 1.6 to 4.2 V, 1.8 to 3.8 V, 1.8 to 3.6 V, etc.).

In some embodiments, the asymmetric electrochemical capacitor positive electrode composition of the asymmetric electrochemical capacitor cell does not include an electroactive metal (i.e., the positive electrode composition excludes electroactive metal) in the cell's normal operating voltage range.

According to some embodiments, the asymmetric electrochemical capacitor cell of the invention further comprises an alkali metal halide salt. In some embodiments, the asymmetric electrochemical capacitor cell of the invention is configured to comprise the alkali metal halide salt in addition to the electrolyte salt that includes a reaction product of an alkali metal halide and an aluminum halide. In some embodiments, the alkali metal of the alkali metal halide salt is selected from sodium, potassium, and lithium. In some embodiments, the alkali metal halide salt is NaCl. In certain embodiments, the asymmetric electrochemical capacitor cell of the invention comprises 5-20 wt % of the sodium metal halide salt, for example, 5, 6, 7, 8, 9, 10, 11, 12, 13, 14, 15, 16, 17, 18, 19, or 20 wt %, including any and all ranges and subranges therein.

According to some embodiments, the asymmetric electrochemical capacitor cell of the invention further comprises a conductive backbone material. For example, in some embodiments, the asymmetric electrochemical capacitor cell comprises 0-10 volume % conductive backbone material, for example, 0, 1, 2, 3, 4, 5, 6, 7, 8, 9, or 10 vol. %, including any and all ranges and subranges therein. The conductive backbone material may comprise one or more constituents that do not participation in reduction or oxidation reactions during cycling of the cell. For example, in some embodiments, the conductive backbone material comprises graphitic carbon, tungsten, and/or molybdenum.

In another aspect, the invention relates to an energy storage device. The device includes a plurality of electrochemical cells housed in a case. At least one of the plurality of electrochemical cells is a first asymmetric electrochemical capacitor cell that includes an asymmetric electrochemical capacitor positive electrode composition as described above, which includes activated carbon and an electrolyte salt that includes a reaction product of an alkali metal halide and an aluminum halide.

In some embodiments of the energy storage device, at least one of the plurality of electrochemical cells is a sodium metal chloride cell having a positive electrode composition different from the asymmetric electrochemical capacitor positive electrode composition of the first asymmetric electrochemical capacitor cell. For example, in some embodiments, the energy storage device may comprise one or more asymmetric electrochemical capacitor cells comprising an asymmetric electrochemical capacitor positive electrode composition according to the present invention, together with one or more electrochemical cells (which may be typical electrochemical cells or asymmetric electrochemical capacitor cells) comprising, e.g., a second positive electrode composition which may be any positive electrode composition known in the art (e.g., a positive electrode composition comprising nickel). In some embodiments, all of the plurality of electrochemical cells have the same positive electrode composition. In some embodiments, the energy storage device may be rechargeable over a plurality of charge-discharge cycles.

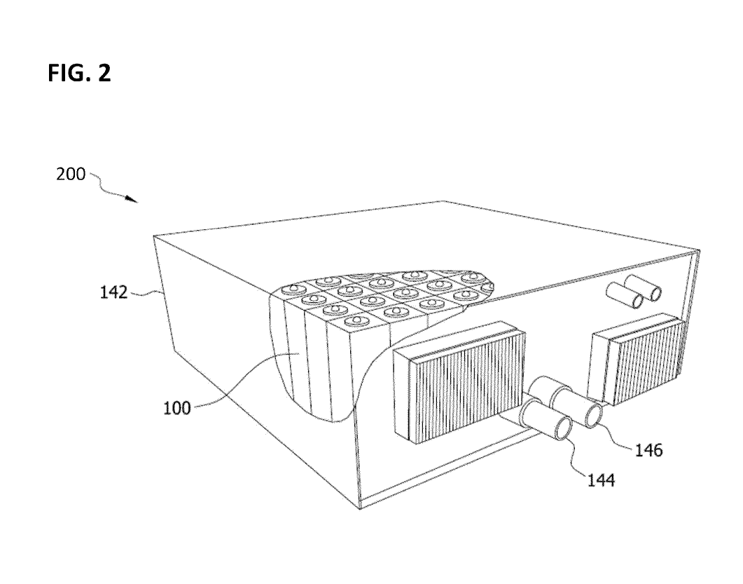

In some embodiments, the energy storage device is a battery. Referring to FIG. 2, a battery 200 according to an embodiment of the invention is provided. The battery 200 comprises a battery case 142 and a plurality of electrochemical cells 100. The plurality of electrochemical cells 100 of battery 200 are connected in series or in parallel, or a combination thereof. As depicted in FIG. 2, in some embodiments, the battery 200 comprises a cooling inlet 144 and a cooling outlet 146 that allow for a cooling medium to be circulated around electrochemical cells 100. In some embodiments, the battery also comprises cooling fins (not shown) disposed between one or more rows of electrochemical cells 100.

Several embodiments of the invention are described in the examples below.

### EXAMPLES

### Example A

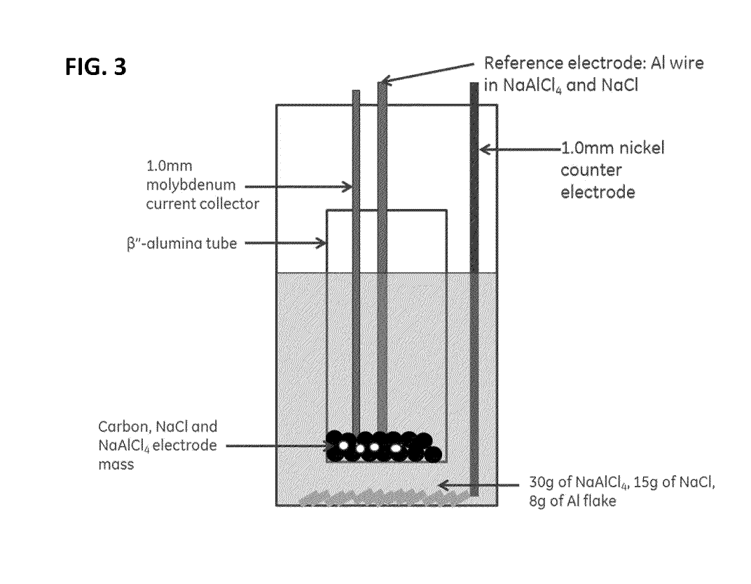

A first sample cell was prepared as follows. FIG. 3 is a simple schematic which represents the testing setup used to test various embodiments of the invention. A reference electrode was constructed by placing 0.2 g of NaCl (Custom Powders, Item Milled PDV), and 0.2 g of NaAlCl₄ (Sigma Aldrich, Item 407402) powders into a close-end Pyrex tube with internal diameter at least 1.3 mm diameter with a length of 1.0 mm diameter aluminum wire (Alfa Aesar, 99.999%, Item 10747), which was well submerged in the powders. The reference electrode had a potential of 1.58V versus an Na/Na+ electrode.

In a 100 ml Pyrex flask (Ace Glass, Item 9448-10) 30 g of NaAlCl₄ (Sigma Aldrich, Item 407402), 15 g of NaCl (Custom Powders, Item Milled PDV), and 8 g of aluminum flake (Alfa Aesar, 99.5%, Item 11067) were placed in the bottom and the entire contents were heated to the desired temperature (200-300° C.).

5 g of NaAlCl₄, 0.25 g of NaCl and 1 g of carbon (Norit SX-Ultra from Sigma Aldrich, Item 53663) were added to a sodium-conducting beta″-alumina tube (Iontec, Ltd., Item A1). Next, a 1.0 mm diameter coiled molybdenum wire (Alfa Aesar, 99.94%, Item 10039) and the assembled reference electrode were placed inside the tube. The complete beta-alumina assembly with electrodes was placed in the already heated 100 ml Pyrex flask and allowed to sit until the complete assembly comes to the desired temperature set point.

Once at temperature, electrode connections were made to the following:
Reference lead wire was connected to the assembled reference electrode.
Counter lead wire was connected to a 1.0 mm diameter nickel wire (Alfa Aesar, 99.5%, Item 14337) in contact with the aluminum flake.
Working lead wires were connected to the molybdenum wire in contact with the carbon/NaCl mixture.

### Example B

A second sample cell was prepared using the same process as described in Example A, except 1 g YP-50F from Kuraray Chemical (Item YP-50F) was used as the carbon instead of the Norit SX-Ultra.

Testing the Cells of Example A and Example B.

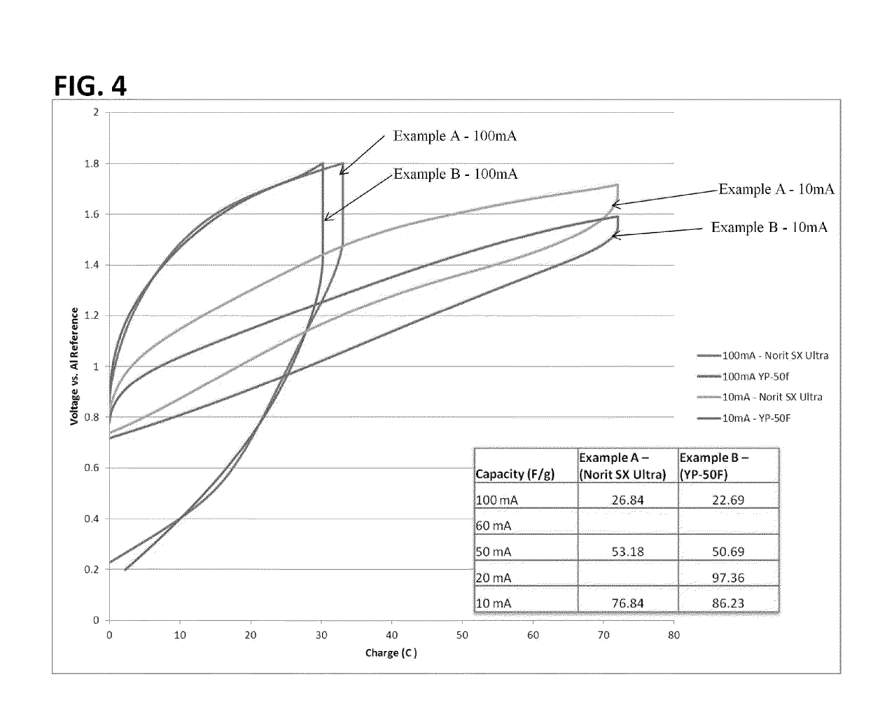

Charging of the cells of Example A and Example B was accomplished through the application of a constant current until the desired upper voltage limit or time limit was achieved. Discharging was accomplished by demanding a desired current until a lower voltage or time limit was achieved. Results are shown in FIGS. 4-10.

FIG. 4 is a chart showing rate dependency of the systems of Examples A and B according to the present invention, and the effect of the different carbons used in the Examples on the rates. Testing was performed at 300° C. As illustrated, both Example A and B exhibited satisfactory resistivity at 10 mA and 100 mA, although impedance was somewhat higher at 100 mA than at 10 mA. Examples A and B were also tested at 50 mA (not shown in chart), and Example B was also tested at 20 mA (not shown in chart). Capacitance (F) per unit material was calculated based on the values from the chart, with results shown in the table (inset, FIG. 4).

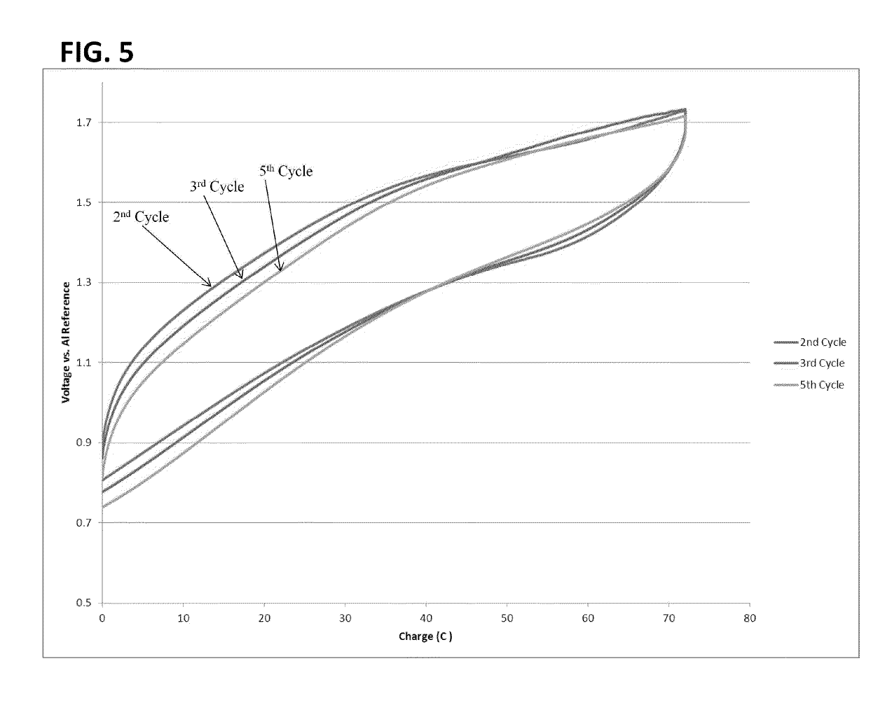

FIG. 5 is a chart showing that the Example A cell was stable over 5 cycles.

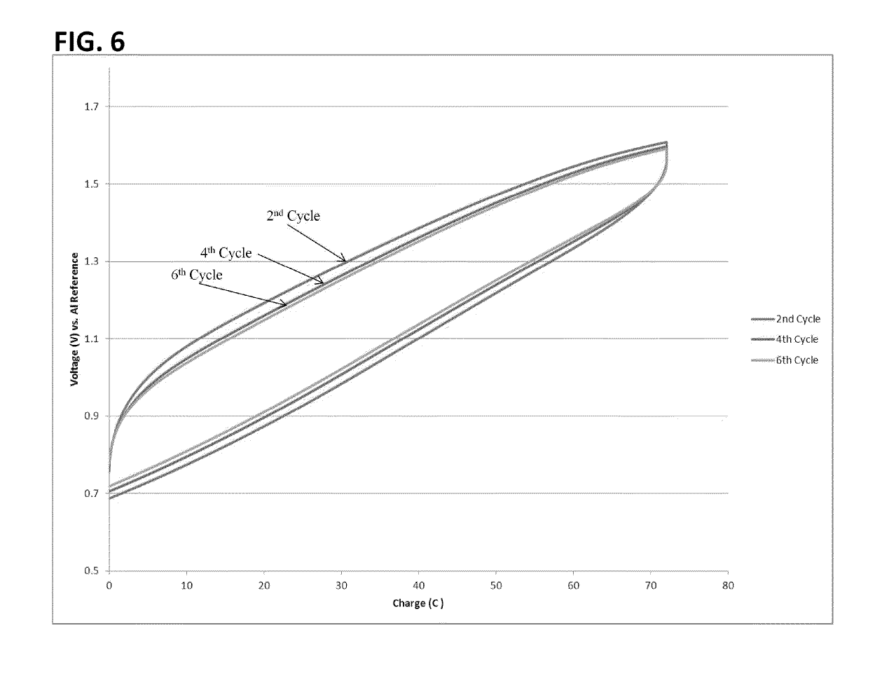

FIG. 6 is a chart showing that the Example B cell was stable over 6 cycles.

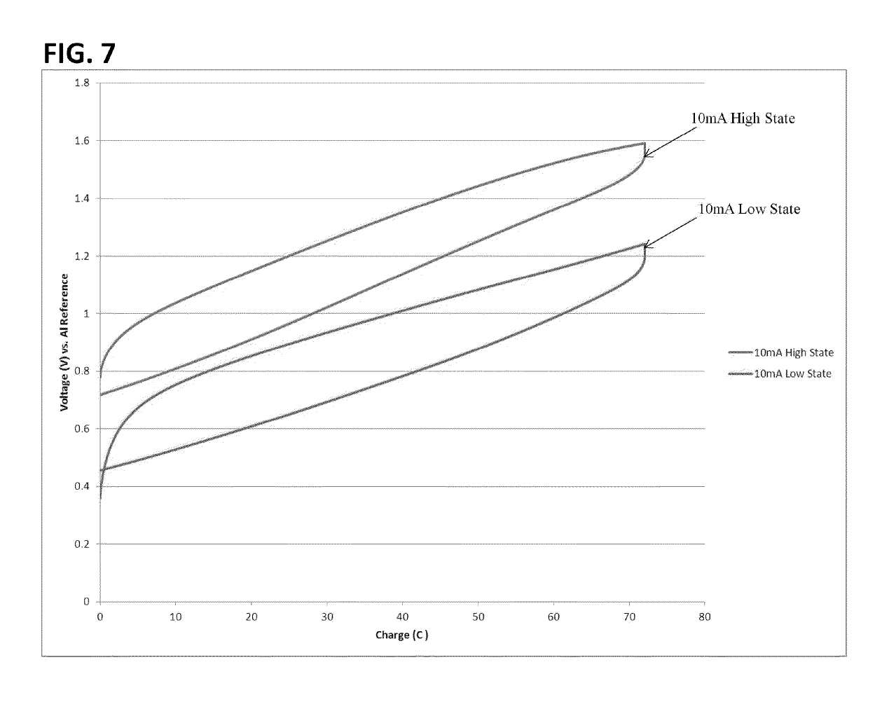

FIG. 7 is a chart showing that the behavior of the Example B cell was consistent at both a high state of charge and a low state of charge. The “High State” was performed at 70% state of charge, whereas the “Low State” was performed at 30% state of charge.

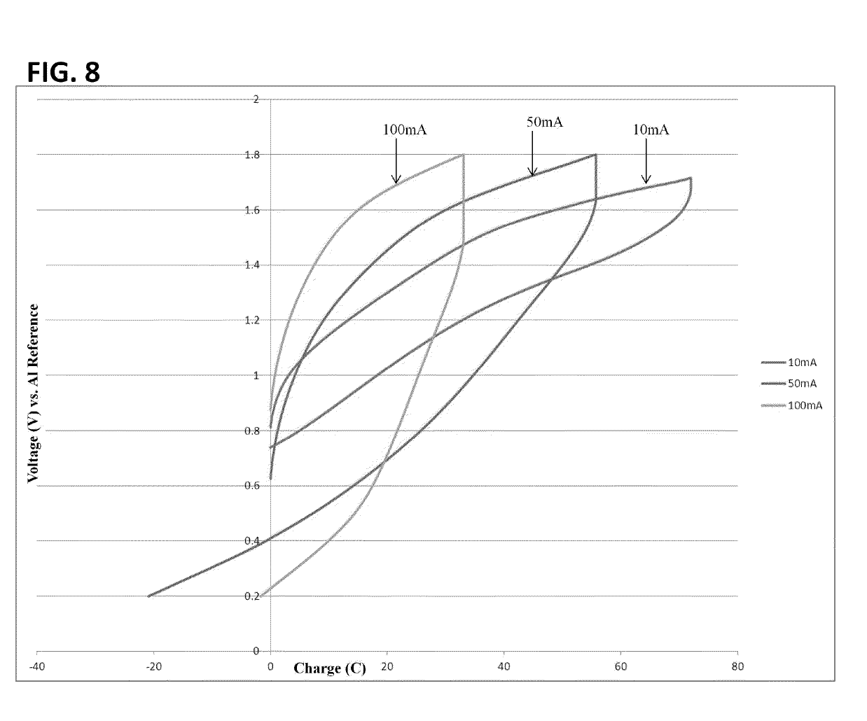

FIG. 8 is a chart showing capacity of the Example A cell as a function of rate.

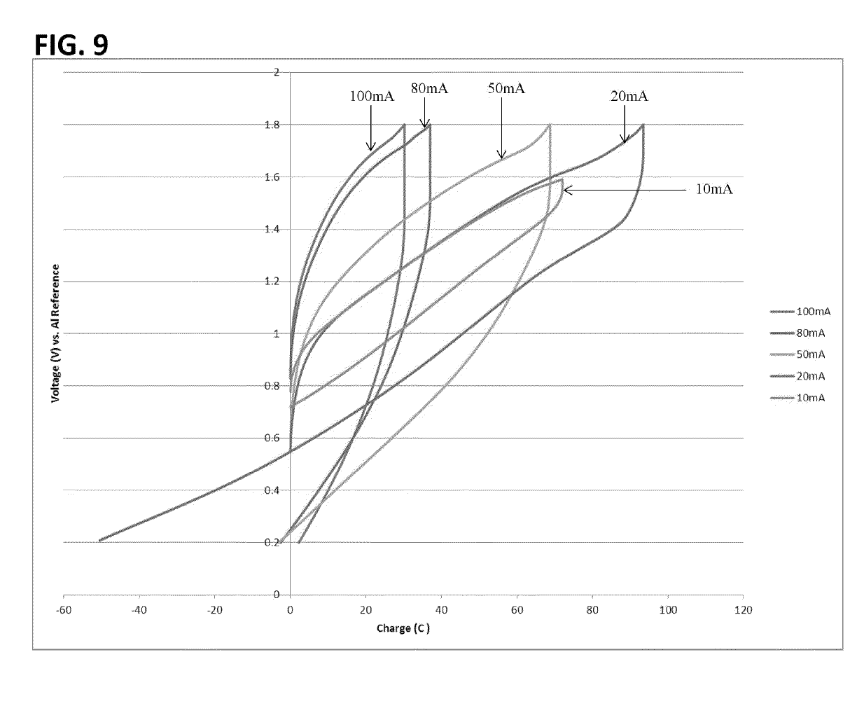

FIG. 9 is a chart showing capacity of the Example B cell as a function of rate.

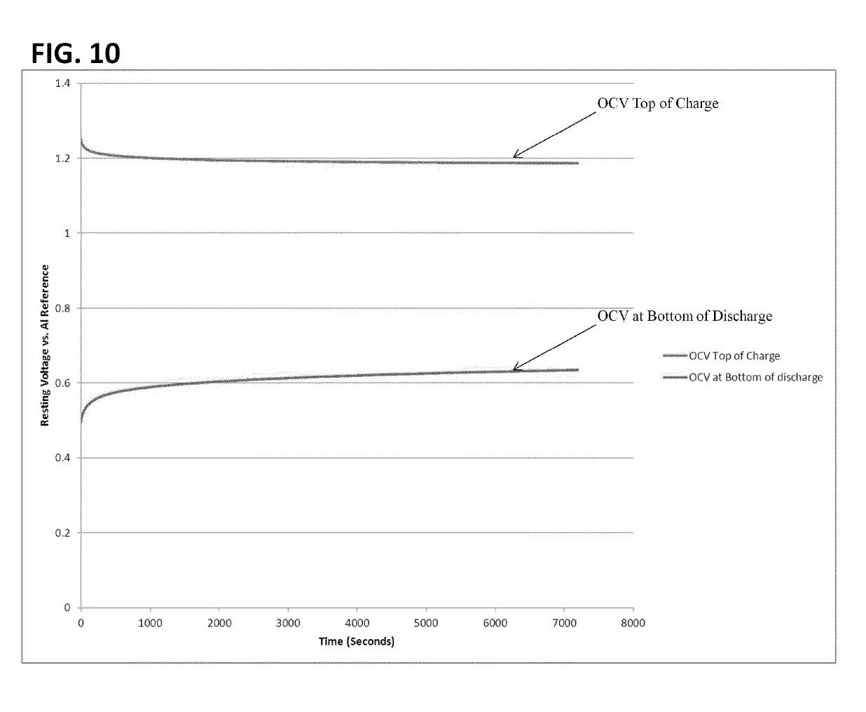

FIG. 10 is a chart showing that the Example B cell was stable, and held its open circuit voltage (OCV) at top of charge and bottom of charge.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form contain, such as “contains” and “containing”) are open-ended linking verbs. As a result, a method or device that “comprises”, “has”, “includes” or “contains” one or more steps or elements possesses those one or more steps or elements, but is not limited to possessing only those one or more steps or elements. Likewise, a step of a method or an element of a device that “comprises”, “has”, “includes” or “contains” one or more features possesses those one or more features, but is not limited to possessing only those one or more features. Furthermore, a device or structure that is configured in a certain way is configured in at least that way, but may also be configured in ways that are not listed.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the various embodiments without departing from their scope. While the dimensions and types of materials described herein are intended to define the parameters of the various embodiments, they are by no means limiting and are merely exemplary. Many other embodiments will be apparent to those of skill in the art upon reviewing the above description. The scope of the various embodiments should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, if present, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure. It is to be understood that not necessarily all such objects or advantages described above may be achieved in accordance with any particular embodiment. Thus, for example, those skilled in the art will recognize that the systems and techniques described herein may be embodied or carried out in a manner that achieves or optimizes one advantage or group of advantages as taught herein without necessarily achieving other objects or advantages as may be taught or suggested herein.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the disclosure may include only some of the described embodiments. Accordingly, the invention is not to be seen as limited by the foregoing description, but is only limited by the scope of the appended claims.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. An asymmetric electrochemical capacitor positive electrode composition comprising activated carbon and an electrolyte salt comprising a reaction product of an alkali metal halide and an aluminum halide.

2. The asymmetric electrochemical capacitor positive electrode composition according to claim 1, wherein the alkali metal of the alkali metal halide is selected from sodium, potassium, and lithium.

3. The asymmetric electrochemical capacitor positive electrode composition according to claim 1, wherein the halide of the alkali metal halide and the halide of the aluminum halide are both chlorine.

4. The asymmetric electrochemical capacitor positive electrode composition according to claim 1, wherein the electrolyte comprises sodium tetrachloroaluminate (NaAlCl₄).

5. The asymmetric electrochemical capacitor positive electrode composition according to claim 1, wherein the activated carbon is present in a range of 5-50 wt % of the asymmetric electrochemical capacitor positive electrode composition.

6. An asymmetric electrochemical capacitor cell comprising:
an outer housing; and
a separator disposed in the outer housing and defining a positive electrode compartment and a negative electrode compartment;
wherein the positive electrode compartment comprises an asymmetric electrochemical capacitor positive electrode composition according to claim 1.

7. The asymmetric electrochemical capacitor cell according to claim 6, wherein the alkali metal of the alkali metal halide is selected from sodium, potassium, and lithium.

8. The asymmetric electrochemical capacitor cell according to claim 6, wherein the halide of the alkali metal halide and the halide of the aluminum halide are both chlorine.

9. The asymmetric electrochemical capacitor cell according to claim 6, wherein the electrolyte comprises sodium tetrachloroaluminate (NaAlCl₄).

10. The asymmetric electrochemical capacitor cell according to claim 6, wherein the activated carbon is present in a range of 5-50 wt % of the asymmetric electrochemical capacitor positive electrode composition.

11. The asymmetric electrochemical capacitor cell according to claim 10, wherein the activated carbon is present in a range of 15-45 wt % of the asymmetric electrochemical capacitor positive electrode composition.

12. The asymmetric electrochemical capacitor cell according to claim 6, further comprising 5-20 wt % of an alkali metal halide salt and 0-10 vol. % of a conductive backbone material.

13. The asymmetric electrochemical capacitor cell according to claim 6, wherein the asymmetric electrochemical capacitor cell is operational in the temperature range of 250 to 450° C.

14. The asymmetric electrochemical capacitor cell according to claim 13, wherein the asymmetric electrochemical capacitor cell is operational in the temperature range of 275 to 425° C.

15. The asymmetric electrochemical capacitor cell according to claim 6, wherein the negative electrode compartment comprises an anodic material, said anodic material comprising sodium.

16. The asymmetric electrochemical capacitor cell according to claim 6, wherein the separator is a solid separator capable of transporting sodium cations between the positive electrode compartment and the negative electrode compartment.

17. The asymmetric electrochemical capacitor cell according to claim 16, wherein the negative electrode compartment comprises an anodic material, said anodic material comprising sodium.

18. The asymmetric electrochemical capacitor cell according to claim 17, wherein the electrolyte is sodium tetrachloroaluminate (NaAlCl₄), and wherein the cell is operational over the voltage range of 1.8 to 3.8 V.

19. An energy storage device comprising a plurality of electrochemical cells housed in a case, wherein at least one of the plurality of electrochemical cells is a first asymmetric electrochemical capacitor cell according to claim 18, and wherein the energy storage device is operational in the temperature range of 275 to 425° C.

20. The energy storage device according to claim 19, wherein at least one of the plurality of electrochemical cells is a sodium metal chloride cell having a positive electrode composition different from the positive electrode composition of the first asymmetric electrochemical capacitor cell.
